(19) United States
(12) Patent Application Publication
(10) Pub. No.: US 2008/0114604 A1
(43) Pub. Date: May 15, 2008

(54) METHOD AND SYSTEM FOR A USER INTERFACE USING HIGHER ORDER COMMANDS

(75) Inventors: Yuan-Jun Wei, Hoffman Estates, IL (US); Mir F. Ali, Schaumburg, IL (US); Paul C. Davis, Chicago, IL (US); Deborah A. Matteo, Schaumburg, IL (US); Steven J. Nowlan, South Barrington, IL (US); Dale W. Russell, Palatine, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/560,139

(22) Filed: Nov. 15, 2006

(51) Int. Cl. G10L 21/00

(52) U.S. Cl. 704/275; 704/E15.04

(57) ABSTRACT

A Higher Order Command Dialog System (HOCS) 250 for enabling voice control to a user interface is provided. The HOCS can record (302) a sequence of action steps a user performs while navigating a menu system to perform a task, prompt (304) a user to create an HOC for the task, and associate (306) the sequence of actions steps with a Higher Order Command (HOC) for performing the task. The HOC can include multi-modal inputs (120/260) and prompt a user for non-specific additional information (124) required in performing the task. The HOCS can store the HOC as a voice tag or a user-input command.

### FIELD OF THE INVENTION

The present invention relates to user interfaces, and more particularly, to voice dialogue systems.

### BACKGROUND

The use of portable electronic devices, radios, and mobile communication devices has increased dramatically in recent years. Moreover, mobile phones and other mobile computing devices have become more widely available, with an increasing number of applications deployed on them. Mobile phones are offering more features that introduce complex navigation systems for accessing the features. Mobile phones generally only provide a limited size user interface such as a keypad and display for navigating menu features. Accordingly, a user must generally traverse a hierarchy of menus to access a feature or perform a task. Despite user-interface design efforts, multi-step navigations are still generally required for most applications. That is, a user must generally perform a sequence of steps in order to perform a task on the mobile phone. This has a negative impact on productivity and the user's experience with the mobile device.

For example, a naïve user may not be familiar with a newly purchased mobile device. Accordingly the user may spend considerable time accessing menus for determining the correct navigation steps for certain applications. Moreover, the user may subsequently forget the navigation steps and have to repeat the process again. Conversely, a power user (i.e. one who frequently uses the mobile phone) might use several applications frequently. Even though the user may know the correct operations, the user must still go though the same sequences of actions repeatedly, hence making inefficient use of time. Moreover, if the user is driving a car or engaged in other activities requiring a high degree of concentration, it may not be possible to carry out such complicated navigation tasks. Moreover, a power user may want to carry out several high impact applications at the same time. For example, a user may desire to respond to an email and follow up the email with a phone call. To do this, the user has to setup and execute each application separately which may hinder productivity. Accordingly, a need exists for a user interface that simplifies navigational access on a mobile device.

### SUMMARY

Broadly stated, embodiments of the invention are directed to a voice controlled user interface for providing multi-modal interaction with a navigation system on a mobile device. Specifically, a Higher Order Command System (HOCS) is provided to create Higher Order Commands (HOCs) which are a compact command representation for a sequence of action steps a user performs in association with a task. One embodiment is directed to a method of creating and processing a voice tag HOC. The method can include recording a sequence of action steps a user performs while navigating a menu system to perform a task and associating the sequence of action steps with a Higher Order Command (HOC) for performing the task. The step of recording the HOC can include prompting the user to save the HOC as a voice tag, and capturing a voice recording for creating the voice tag. The user can also be prompted to create the voice tag in a preferred modality which may be a text-input or voice-input modality. The action steps recorded can also be multi-modal. Upon receiving the voice tag, the corresponding sequence of action steps can be automatically performed for performing the task.

The method can further include determining when an action step requires a non-specific parameter to complete task, and prompting the user for the non-specific parameter when the HOC encounters the action step in performing the task. The non-specific parameter may prompt the user for additional information associated with an action step. In one aspect, HOCs can be automatically created by parsing the navigation menu system or menu documentation for menu paths. The user can be prompted for a voice tag to associate with one or more of the menu paths. The method can also include determining when the user is in a process of performing a task and prompting the user to create an HOC in response. The method can further include determining when the user has entered a misleading action step in performing the task, and discarding the misleading action step in the sequence of action steps of the HOC. Unnecessary action steps, such as those not relevant to the task, can also be removed from the sequence of action steps specified in the HOC. A check can also be performed to determine if similar HOCs were previously created. The user can be informed of similar sounding voice tags, or voice tags associated with a similar task. Upon creation of an HOC, a validity check can be performed to ensure the sequence of action steps correctly performs the task. HOCs requiring a long series of action steps can also be replaced with a shorter equivalent series of action steps, reducing the sequence of action steps to perform the task.

Another embodiment is directed to a Higher Order Command Dialog system (HOCDS). The HOCDS can include a base dialog system (BDS) having a navigation structure that allows a user to perform a sequence of action steps for performing a task, and a Higher Order Command system (HOCS) communicatively coupled to the BDS for creating and processing BDS commands. The HOCDS can parse the navigation structure for BDS commands in response to the sequence of action steps and create Higher Order Commands (HOCs) to associate with the sequence of action steps. The HOCDS can include a Graphical User Interface (GUI) for visually presenting the navigation structure of the BDS, a keypad operatively coupled to the GUI for receiving user input to perform the sequence of action steps in the navigation structure, and a voice user interface (VUI) operatively coupled to the keypad for creating voice recognition commands to associate with the sequence of action steps. The HOCDS can include a controller operatively coupled to the GUI, keypad, and VUI for receiving the HOC and performing the sequence of action steps in response to the HOC, such that when the user issues the HOC, the processor automatically performs the task. The controller can prompt the user for user-input when additional information, such as a non-specific parameter, is required to process an action step associated with the task. The controller can present the additional information through a text modality or a voice modality, and similarly store the sequence of action steps in a modality selected by the user.

Another embodiment is also provided that includes a method for creating a Higher Order Command (HOC). The method can include capturing a sequence of action steps a user performs while navigating a menu system to perform a task, associating the sequence of action steps with a Higher Order Command (HOC), and prompting the user for information that is required for completing an action step associated with the task. The information may be non-specific for completing the task. The method can include pausing the capturing of action steps, allowing for the insertion of non-specific information, and then resuming the capturing of action steps. The HOC can include a placeholder for the non-specific information. The user can be prompted for the non-specific information when the HOC encounters the action step. The prompting can include identifying variable items in the task, and creating a template that includes the information in the variable item for including with the HOC. Additional information can be associated with an email application, a voice mail application, a voice call, or a bluetooth operation.

### BRIEF DESCRIPTION OF THE DRAWINGS

The features of the system, which are believed to be novel, are set forth with particularity in the appended claims. The embodiments herein can be understood by reference to the following description, taken in conjunction with the accompanying drawings, in the several figures of which like reference numerals identify like elements, and in which:

FIG. 1 is a mobile device having a base dialog system BDS that implements a higher order command system (HOCS) in accordance with the embodiments of the invention;

FIG. 2 is an exemplary navigation structure for a base dialog system (BDS) in accordance with the embodiments of the invention;

FIG. 3 is an exemplary higher order command (HOC) in accordance with the embodiments of the invention;

FIG. 4 is a block diagram of the HOCS of FIG. 1 in accordance with the embodiments of the invention;

FIG. 5 is a list of methods for optimizing the HOCS of FIG. 4 in accordance with the embodiments of the invention;

FIG. 6 is a method for creating higher order commands (HOCs) in accordance with the embodiments of the invention;

FIG. 7 is a method for processing an HOC in accordance with the embodiments of the invention;

FIG. 8 is an example of a task requiring a sequence of multi-mode action steps in accordance with the embodiments of the invention;

FIG. 9 is a method for creating a voice tag for an HOC in accordance with the embodiments of the invention;

FIG. 10 is an example of a task requiring non-specific information for creating an HOC in accordance with the embodiments of the invention; and

FIG. 11 is a method for including non-specific information in an HOC in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

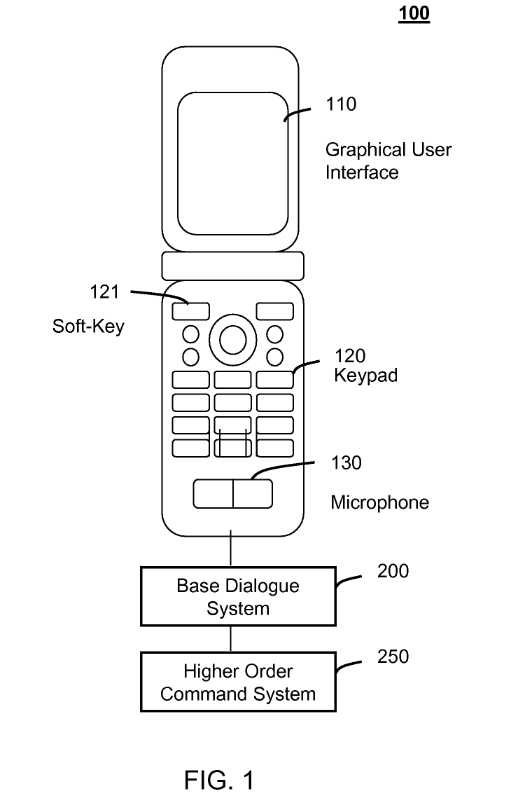

Referring to FIG. 1, a mobile device 100 providing higher order command (HOC) options is shown. The mobile device can include a graphical user interface (GUI) 110 for displaying information, a keypad 120 for entering data, and a microphone 130 for capturing voice as is known in the art. The keypad 120 can include one or more soft-keys 121 for selecting menu items presented in the GUI 110. More specifically, the mobile device can include a base dialogue system (BDS) 200 for providing a menu navigation structure, and a higher order command system (HOCS) 250 for automatically navigating the BDS 200 in response to a voice command or user-input command.

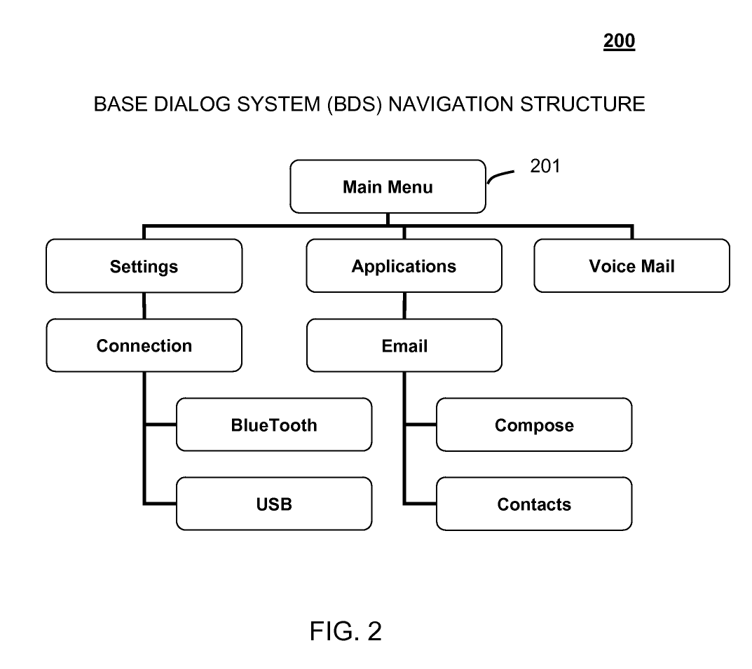

As shown in FIG. 2, the base dialogue system (BDS) 200 can be a navigation structure for allowing a user to navigate through menus displayed in the GUI 110. In one aspect, the BDS 200 can include a hierarchy of menu items 201 for performing a task. Each menu item in the BDS 200 can lead to one or more other menus items for accessing a feature or performing a task on the mobile device 100. Notably, the mobile device 100 presents the menu items in the GUI 110 in accordance with the navigation structure of the BDS 200 as the user navigates menus in the GUI 110.

Referring back to FIG. 1, the HOCS 250 can create higher order commands (HOCs) to allow a user to access one or more features of the mobile device 100 or perform one or more tasks automatically, without requiring the user to manually navigate through the BDS 200. That is, the HOCS 250 automatically executes the action steps generally required as input from the user for accessing a feature or performing a task. In response to a sequence of action steps performed by a user, the HOCS 250 can parse the corresponding navigation structure and create Higher Order Commands (HOC) to associate with the sequence of action steps.

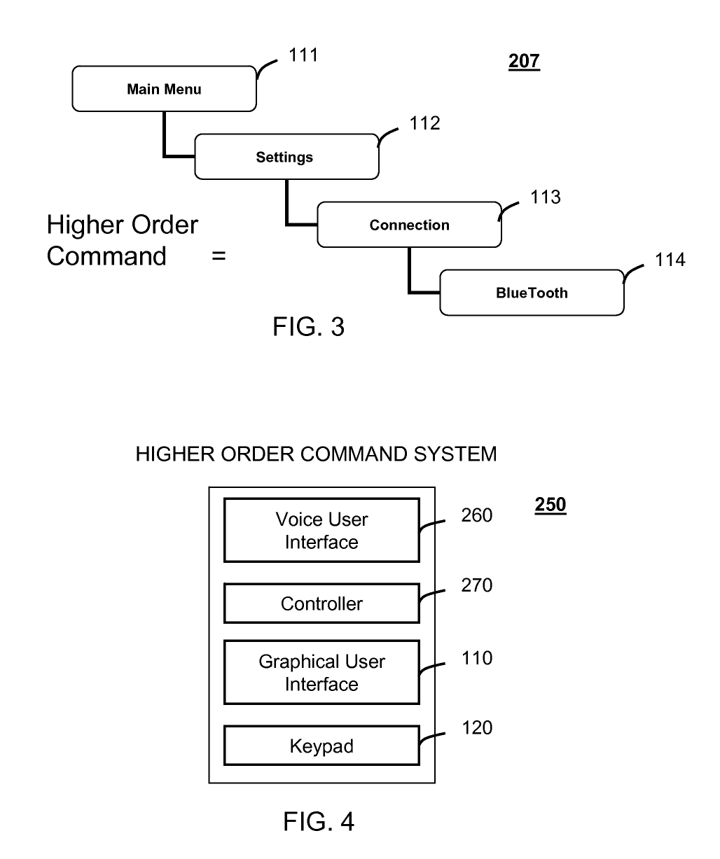

Referring to FIG. 3, an exemplary HOC 207 for accessing a menu path of the BDS 200 (See FIG. 2) is shown. The HOC 207 may be of a voice modality or a user-input modality. For example, a voice tag can be associated with the HOC 207 for automatically performing the menu entries. The exemplary HOC 207 defines action steps performed by the user for performing a task, such as accessing a Bluetooth feature 114. For example, the HOC specifies action steps for accessing a MainMenu item 111, followed by a Settings menu item 112, followed by a Connection menu item 113, followed by a Bluetooth menu item 114 instead of requiring the user to press a soft-key 121 repeatedly. An HOC can also include a sub-sequence of action steps representing a macro or a built-in shortcut. Notably, the HOCS 250 (See FIG. ??) processes the HOC 207 to automatically access the Bluetooth menu 114. The HOC 207 can be a user-input command, such as a single soft-key press, a key-stroke, or a voice recognition command that is mapped to a sequence of commands. Moreover, the HOC 207 can include additional information which may be required to complete an action step.

Referring to FIG. 4, a block diagram of the HOCS 250 of FIG. 1 is shown. The HOCS 250 can be implemented in hardware, such as an Integrated Circuit (IC), Application Specific Integrated Circuit, Field Programmable Gate Array (FPGA) or any other suitable electronic device, component, or system and is not limited to these. Alternatively, the HOCS 250 can be implemented on a microprocessor or Digital Signal Processor or any other suitable processor using suitable programming code and is not limited to these. The HOCS 250 can include a Voice User Interface (VUI) 260 for associating a voice recognition command with a HOC, and a controller 270 operatively coupled to the VUI 260, the GUI 110, and the Keypad 120 for executing the sequence of action commands specified by the HOC 207. For example, a user can speak a voice command for automatically performing a sequence of action steps associated with a task. As another example, a user can press a soft-key 121 for performing the sequence of action steps. In one aspect, the HOCS 250 can automatically parse the navigation system structure or structured documentation of the BDS 200 to generate HOCs. That is, the HOCS can scan the BDS and automatically create HOCs for the user. The HOC 250 can then prompt the user to provide a voice tag or user-input command for each HOC. That is, the HOCS 250 can prompt the user to define a name for an HOC in a preferred modality interaction.

Briefly, the HOCS 250 creates a higher order command (HOC) for a sequence of actions steps a user takes when performing a task to simplify user interaction with the mobile device 100. The HOCS 250 can use the human voice to represent tasks or subtasks so that the user can easily execute the tasks or subtasks, particularly in mobile environments. This provides an alternate mechanism for GUI based user-input interfaces which generally require a user to manually perform the steps of the task. Moreover, due to limited display space on a mobile device, it is generally not possible to display a large number of macros. Too many GUI and keypad based macros generally defeat a purpose of structured navigation systems. Furthermore, in a mobile environment such as a vehicle, it is not generally safe or practical for a user of a mobile device to handle a GUI and keypad interfaces when driving. Accordingly, the HOCS 250 provides voice recognition command as a preferable alternative to manually entering in macros.

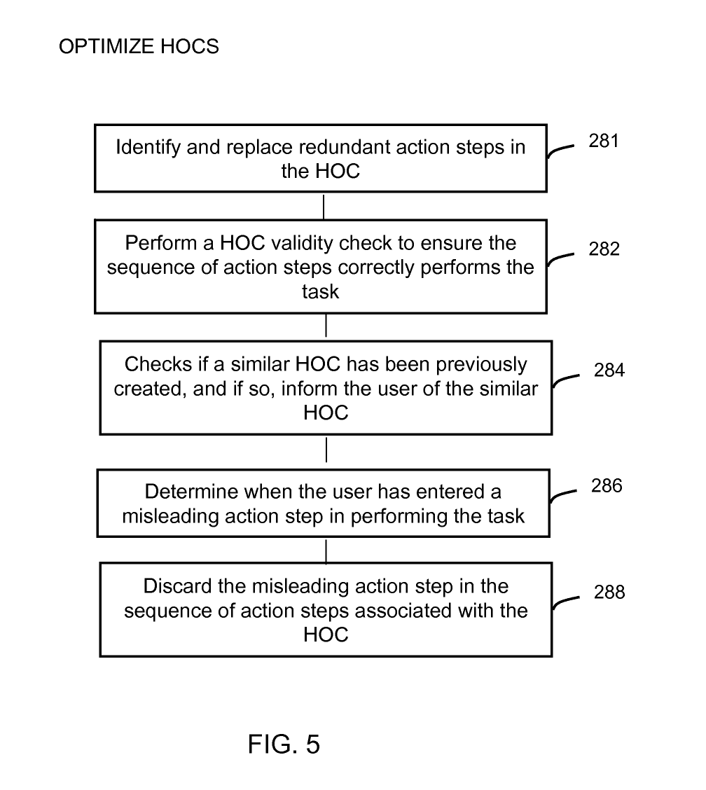

Referring to FIG. 5, the HOCS 250 can include self optimization processes. In one arrangement, the HOCS 250 can identify and replace redundant paths for reaching a menu item or performing a task (step 281). For example, in applications that can be reached via more than one path through the BDS 200, only the shortest one is stored. Furthermore, the HOCS 250 can perform a HOC validity check to ensure the sequence of action steps correctly performs the task (Step 282). The HOCS 250 can also check if a similar HOC has been previously created, and if so, inform the user of the similar HOC (step 284). It should also be noted, that the HOCS can determine which steps are unnecessary and should not be included in the HOC. As one example, a user may temporarily access a help menu for completing a task. The HOCS 250 can exclude the help menu in the HOC. As another example, the HOCS 250 can determine when a user enters a misleading step in performing a task (step 286), and discard the misleading step in the sequence of action steps associated with the HOC (step 288). For instance, a user may mistakenly press a soft-key during the task. The HOCS 250 can determine that the user back-tracked a menu in completing a task. The HOCS 250 can then remove the mistaken action step from the HOC. The HOCS 250 can also learn an interaction pattern of the user for creating an HOC. For example, the user may often perform the same task with the same sequence of steps. The HOCS can determine how frequent the user performs the task in relation to other tasks and prompt the user to create an HOC for the task. Moreover, the HOCS 250 can keep track of the number of mistakes a user makes in performing a task, such accessing a menu hierarchy. The HOCS can count the number of mistakes and prompt the user to create an HOC to avoid further mistakes.

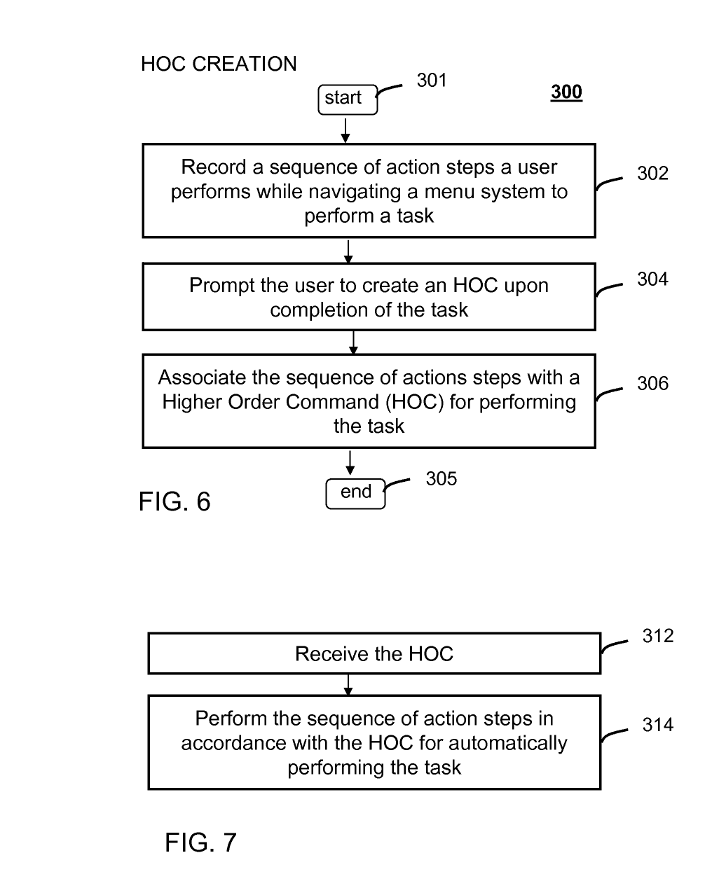

Referring to FIG. 6, a method 300 for creating an HOC is shown. The method 300 can be practiced with more or less than the number of steps shown. The method 300 is also not limited to the order in which the steps are shown. When describing the method 300, reference will be made to FIGS. 1 and 4 although it must be noted that the method 300 can be practiced in any other suitable system or device.

At step 301, the method 300 can start. At step 302 a sequence of action steps a user performs while navigating a menu system to perform a task can be recorded. The actions steps may be a user-input, such as pressing a soft-key, or a voice input, such as a voice recognition command. For example, referring to FIG. 1, when a user is in the process of carrying out a task, the HOCS 250 records the input sequence to trace the action steps. Upon the completion of the task, at step 304, the HOCS 250 gives the user an option to create an HOC for that sequence of actions (e.g. BDS commands). For example, referring to FIG. 4, the GUI 110 can present a dialogue for saving an HOC to associate with the task. In the context of a multi-modal dialog system, the sequence of BDS commands can come from different modalities, such as user-input or voice input. Hence there are no constraints on the representation of action steps in different modalities. The representation of action steps can cover any one modality or any combination of modalities. At step 304, the sequence of actions steps can be associated with a Higher Order Command (HOC) for performing the task. Notably, the HOC is a compact BDS command representation for the sequence of action steps. For example, referring to FIG. 4, the controller 270 can identify the sequence of menu items selected in the GUI 110 from the user input of pressing the soft-keys of the keypad 120. The controller 270 can also commission the VUI 260 to capture a voice tag for associating with the sequence of action steps. At step 305, the method 300 for creating an HOC can end.

Upon creating an HOC, a user can thereafter user the HOC for performing the task. Notably, multiple HOCs can be created for performing different tasks. With reference to FIGS. 1 and 7, upon the HOCS 250 receiving the HOC (step 312), the HOCS 250 can perform the sequence of action steps in accordance with the BDS commands of the HOC for automatically performing the task (step 314).

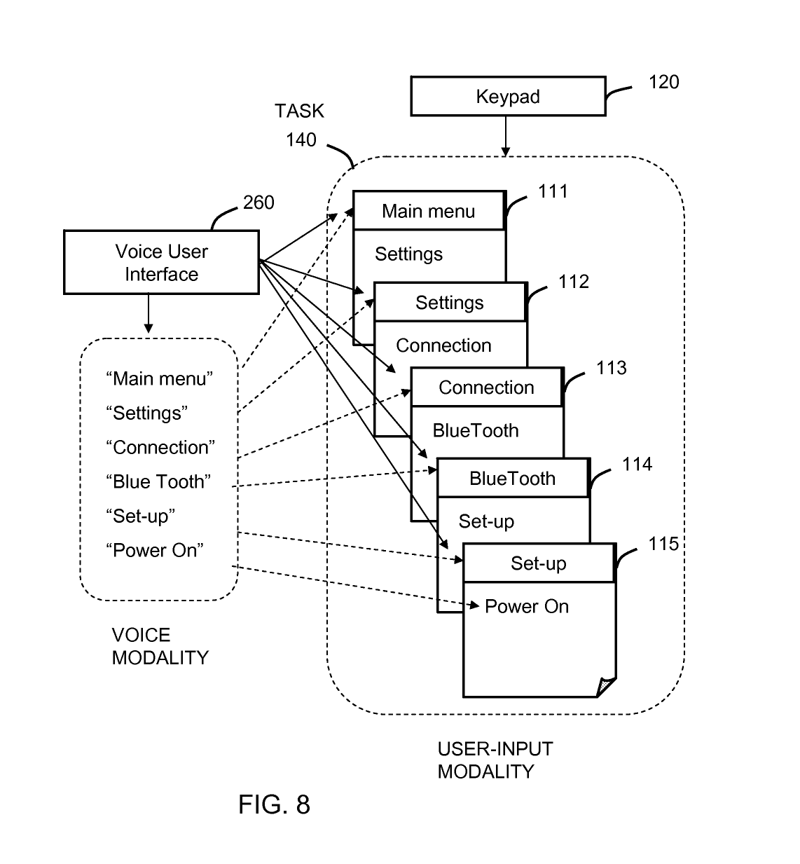

As an example, referring to FIG. 8, the sequence of action steps may correspond to a task 140 for powering a blue tooth connection. In general, to pair the mobile device 100 with a bluetooth device (not shown), the user must turn on the power for the bluetooth device on the phone. A typical set-up procedure may consist of the following steps: open the main menu, select “SETTINGS” 111, select “CONNECTION” 112, select “BLUETOOTH” 113, select “SET UP” 114, and select “POWER ON” 115. In order to save power on the device, the user generally needs to turn off the power whenever the Bluetooth device is not in use. Then the user has to carry out the same sequence of steps to turn the device on again. The sequence of actions steps for entering power-on mode can be stored as an HOC.

Upon the completion of setting up a bluetooth connection, the HOCS 250 can offer the user the option of generating a HOC for this task. The user may generate the HOC in any modality. For example, the user can generate a voice representation and assigning the HOC with the voice tag “Bluetooth”. The HOCS 250 can apply a speech recognizer to the recorded voice tag so that a textual representation is also created for display in a GUI. Note that while the original actions took place in the GUI modality of the dialog system, the corresponding HOC may be created, and thus used, via speech, text, or a combination of modalities

In practice, referring to FIG. 4, the controller 270 can record the sequence of soft-key presses the user performs on the keypad 120 for entering power-on mode. That is, the controller 270 can identify the BDS commands in the BDS 200 (See FIG. 2) underlying the GUI 110 in response to the soft-key presses. It should also be noted that the user can present voice commands to traverse the BDS 200. The VUI 260 can process the voice commands and identify the underlying BDS commands in the BDS 200 (See FIG. 2). For example, referring back to FIG. 8, the user may speak one or more menu items instead of manually pressing a soft-key. Upon completion of the task, the controller 270 can prompt the user to store the task as an HOC. In one arrangement, the GUI 110 may present a visual message to the user for informing the user of an option to create the HOC. The user may also be prompted to save the HOC as a voice tag.

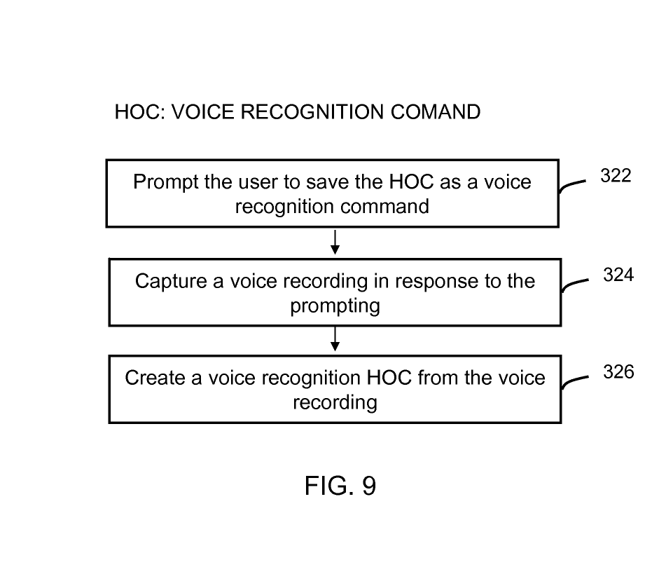

Referring to FIG. 9, the controller 270 can prompt the user to save the HOC as a voice recognition command (step 322). The VUI 260 can then capture a voice recording from the user in response to the prompting (step 324), and create a voice recognition HOC from the voice recording (step 326). Thereafter, upon receiving the voice recognition command, the HOCS 250 can automatically perform the sequence of action steps for the task. The intermediate system outputs that are associated with basic commands are disabled, so that the multi-step dialog sequence of the BDS is reduced to one (or more) dialog steps in HDS. Briefly, referring bak to FIG. 8, for example, the main menu of the voice user interface 260 can provide a one-step transition directly to Bluetooth 14. That is, the user can present a voice command to access a Bluetooth features without traversing through the voice menu hierarchy 110-114.

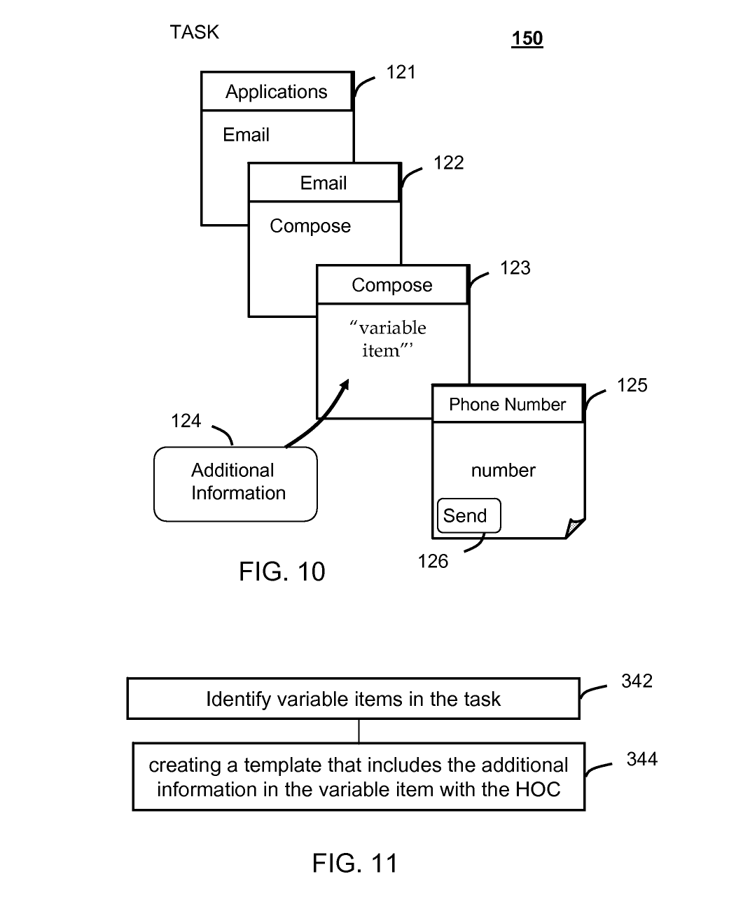

Referring to FIG. 10, another examplary task 150 is shown. Briefly, the task 150 is a repetitive task that is repeatedly performed by a user and that includes various user inputs. In particular, the sequence of action steps performed by the user is multi-modal. That is, the user interacts with the device in more than one mode. Specifically, a user-input modality including pressing softkeys is provided, and a voice-input modality including entering in voice messages is provided. Notably, various modalities and their usage are herein contemplated and are not limited to those presented in FIG. 10 The sequence of action steps for performing the task 150, including the different user-input modalities, can be recorded as an HOC. The HOC can include action steps associated with the user-input modality and the voice modality. In particular, additional information can be included within the action steps of the HOC for performing the task 150. For example, during creation of the HOC, the user can be prompted for additional information that may be required for completing one aspect of the task 150. It should also be noted that the HOC can be invoked in any modality regardless of the modality it was created. In the case of invocation by voice, the user can simply push a soft-key and say the name of the HOC. This effectively visually hides the structure of the navigation system from the user.

FIG. 10 presents an example wherein a user may wish to send the same text message to the user's spouse every afternoon when the user is about to leave the office for home. The user will perform the following sequence of actions: Open the main menu (start from graphical modality), select “Applications” 121, select “Email” 122, select “Compose”, dictate the message “I am on my way home” (switch to voice modality for including the additional information 124), select the spouse's phone number from phone book, and select 'send. Notably, the user has switched modalities between user-input and voice-input for completing the task. After the user sends out the message to the user's spouse, the user creates an HOC with the voice tag “Send Spouse the message”. In this case, both the command steps and the message itself are represented by voice. Note that while the original tasks involve both GUI and VUI, the resulting HOC only requires the user to use VUI for execution. Alternatively, a textual representation of the HOC can also be created.

Referring to FIG. 4, the HOCS 250 can employ the VUI 260 to acquire speech input for voice modalities, or the GUI 11 to acquire input from keypad modalities. The controller 270 can coordinate the creation of the HOC based on the input from the different modalities. For example, referring to FIG. 11, the controller 270 can identify variables in the task 150 associated with the one or more modalities (step 342), and create a template that includes the additional information in the variable item with the HOC (step 344). With respect to FIG. 10, the additional information replacing the variable item is the voice message to the user's spouse. Notably, the additional information may be a text message, a voice mail, voice call information, an image, a video clip, an email option, or any other user information. The HOCS 250 can also support the generation of compound HOCs. That is, a first HOC and a second HOC can be combined to create a compound HOC. For example, the HOC associated with the task 140 of FIG. 7 can be combined with the HOC associated with task 150 of FIG. 10 as a batch mode for performing one or more tasks. Consider, that the user creates a first voice tag called “Bluetooth” for the task 140 and a second voice tag called “Send Message to Spouse” for the task 150. The user can then create a compound HOC by combining the HOC associated with the “Bluetooth” with the HOC associated with the “Call spouse” by saying “Bluetooth and Send Message to Spouse”.

As noted in FIG. 10, the HOCS 250 can prompt a user for additional information when an action step requires information for completing a step in the task 150. In such regard, the HOCS 250 can identify when additional information is required during the creation of an HOC. The HOCS 250 can also determine when an action step requires a non-specific parameter for completing the task, and prompting the user for the non-specific parameter when the HOC encounters the action step associated with the non-specific parameter. For example, a user may wish to create an HOC for sending an image file. The user may perform the same steps for opening and sending the image file, although the user desires to select different image file each time. Accordingly, during the creation of an HOC for sending an image file, the HOCS can determine that the selection of the image file, such as the filename, is a non-specific parameter to the task. The HOCS can then leave a placeholder that prompts the user for the image file when the HOC is presented. In another arrangement, the user can manually turn on and off recording of action steps during creating of the HOC. For example, during recording of the sequence of action steps associated with a selecting the image, the user can electively turn off recording, perform a non-specific operation, and then restart recording. The HOCS can generate a placeholder which prompts the user for the non-specific operation when the HOC is presented. The HOCS 250 can prompt the user for a voice tag, such as “Send Clip”, to associate with the HOC. At a later time, when the user says “Send Clip” the HOCS carries out the sequence of action steps in the BDS 200 for sending the video clip, up to the step where input is required for the image file, and which was not recorded as part of the HOC. At this time, the HOCS 250 prompts the user to supply the information identifying the image clip to be sent, or possibly the address of the recipient which was also considered a non-specific parameter. Upon the user supplying the required information, the HOC resumes the sequence of action steps for performing the task. Notably, the HOCS 250 performs BDS commands in the BDS 200 for performing the sequence of action steps.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A method for user interfacing suitable for use in a mobile device, comprising
recording a sequence of action steps a user performs while navigating a menu system to perform a task; and
associating the sequence of actions steps with a Higher Order Command (HOC) for performing the task,
wherein the HOC is a compact command representation for the sequence of action steps representing a voice modality or a user-input modality.

2. The method of claim 1, further comprising:
receiving the HOC; and
performing the sequence of action steps in accordance with the HOC for performing the task, such that when the user issues the HOC, the task is automatically performed.

3. The method of claim 1, wherein the recording the HOC further comprises:
prompting the user to save the HOC as a voice tag; and
capturing a voice recording in response to the prompting for creating the voice tag,
such that upon receiving the voice recognition command, the sequence of action steps is automatically performed.

4. The method of claim 1, further comprising:
determining when an action step requires a non-specific parameter to complete task; and
prompting the user for the non-specific parameter when the HOC encounters the action step.

5. The method of claim 1, further comprising:
automatically parsing the navigation menu system or menu documentation for menu paths; and
automatically creating multiple HOCs for the menu paths.

6. The method of claim 1, further comprising:
determining when the user is in a process of performing a task; and
prompting the user to create an HOC upon completion of the task.

7. The method of claim 1, wherein the recording further comprises:
determining when the user has entered a misleading action step in performing the task; and
discarding the misleading action step in the sequence of action steps associated with the HOC.

8. The method of claim 1, wherein the associating further comprises replacing a series of long action steps with a series of equivalent short action steps for reducing the sequence of action steps to perform the task.

9. A method for creating a Higher Order Command (HOC), comprising:
capturing a sequence of action steps a user performs while navigating a menu system to perform a task;
associating the sequence of action steps with a Higher Order Command (HOC); and
prompting the user for information that is required for completing an action step associated with the task.

10. The method of claim 9, wherein the prompting further comprises:
identifying variable items in the task; and
creating a template that includes the information in the variable item for including with the HOC.

11. The method of claim 9, wherein the additional information is associated with an email application, a voice mail application, a voice call, or a bluetooth operation.

12. The method of claim 9, further comprising prompting the user to save the HOC as a voice recognition command or as a user-input command.

13. The method of claim 9, wherein the HOC includes a sub-sequence of action steps representing a macro or a built-in shortcut.

14. A Higher Order Command Dialog system, comprising:
a base dialog system (BDS) having a navigation structure that allows a user to perform a sequence of action steps for performing a task; and
a Higher Order Command system (HOCS) communicatively coupled to the BDS, wherein the HOCS parses the navigation structure in response to the sequence of action steps and creates Higher Order Commands (HOC) to associate with the sequence of action steps.

15. The Higher Order Command Dialog system of claim 14, wherein the HOCS further comprises:
a Graphical User Interface (GUI) for visually presenting the navigation structure of the BDS;
a keypad operatively coupled to the GUI for receiving user input to perform the sequence of action steps in the navigation structure; and
a voice user interface (VUI) operatively coupled to the keypad for creating voice recognition commands to associate with the sequence of action steps.

16. The Higher Order Command Dialog system of claim 15, wherein the HOCS further comprises:
a controller operatively coupled to the GUI, keypad, and VUI for receiving the HOC and performing the sequence of action steps in response to the HOC for performing the task, such that when the user issues the HOC, the processor automatically performs the task.

17. The Higher Order Command Dialog system of claim 16, wherein the controller prompts the user for user-input when additional information is required to process the task, wherein the additional information is a text modality of a voice modality.

18. The Higher Order Command Dialog system of claim 16, wherein the controller stores the sequence of action steps in a modality selected by the user.

19. The Higher Order Command Dialog system of claim 16, wherein the controller performs a HOC validity check to ensure the sequence of action steps correctly performs the task.

20. The Higher Order Command Dialog system of claim 16, wherein the controller checks if a similar HOC has been previously created, and if so, informs the user of the similar HOC.
